(19) United States
(12) Patent Application Publication
(10) Pub. No.: US 2004/0141518 A1
(43) Pub. Date: Jul. 22, 2004

(54) Flexible multimode chip design for storage and networking

(76) Inventors: Alison Milligan, Colorado Springs, CO (US); Jonathan Brauer, Georgetown, TX (US); Danny Vogel, Sudbury, MA (US)

Correspondence Address: LSI LOGIC CORPORATION, 1621 BARBER LANE, MS: D-106 LEGAL, MILPITAS, CA, 95035, US

(21) Appl. No.: 10/349,180

(22) Filed: Jan. 22, 2003

(51) Int. Cl. H04L 12/66

(52) U.S. Cl. 370/463

(57) ABSTRACT

The present invention is directed to a flexible multimode chip design for storage and networking. A method for providing a flexible multimode chip may include designing an integrated circuit chip having a sufficient number of customizable gates to implement a communication protocol, the customizable gates implemented in a metal mask layer. The integrated circuit is configured for compliance with a specific protocol in final mask steps of the design of the integrated circuit by defining the specific protocol utilizing the customizable gates. The integrated circuit may also be configured for compliance with at least one specific feature set in final mask steps of the design of the integrated circuit by defining the specific feature set utilizing the customizable gates.

### FIELD OF THE INVENTION

The present invention generally relates to the field of circuit design, and particularly to a flexible multimode chip design for storage and networking.

### BACKGROUND OF THE INVENTION

The design and implementation of integrated circuits has continued to be more complex as size of components has decreased, the number of components has increased, and the range of functionality has increased. Therefore, the challenge to produce integrated circuits having the wide range of functionality desired by customers in the marketplace has made manufacturers who are not able to flexibly provide the desired functionality at a serious competitive disadvantage in the marketplace.

For example, a manufacturer of an integrated circuit is confronted with a variety of standards and protocols which exist for similar chip level products for development for customer needs. Developing integrated circuits which utilize each of these highly complex designs continues to rise dramatically as the chip level geometries shrink, and the functional complexity of the chips rise. This development cost effectively creates a barrier both financially and in engineering resources to product development. This development cost may result in constraining larger companies to fewer designs than desired by potential customers while smaller companies may be prevented from competing altogether.

Therefore, it would be desirable to provide reduced financial and engineering resource costs in the development of integrated circuits in order to enable a wide range of designs across a larger group of developers.

### SUMMARY OF THE INVENTION

Accordingly, the present invention is directed to a flexible multimode chip design for storage and networking. In a first aspect of the present invention, a flexible multimode chip includes at least one serializer/deserializer core for proving an interface. A plurality of customizable gates is communicatively coupled to the at least one serializer/deserializer core. The plurality of customizable gates is configurable to define a communication protocol and at least one specific feature set. A host interface module is included having a host interface processor for providing an interface with a host. A memory interface module is also included for providing a memory interface to a storage device, the memory interface module communicatively coupled to the host interface module. A channel data control module is communicatively coupled to the memory interface module and the at least one serializer/deserializer core. The channel data control module includes a processor for managing context for the memory interface module.

In an additional aspect of the present invention, a data storage system includes a host system, a plurality of storage device suitable for storing electronic data and a flexible multimode chip communicatively coupling the host system with the plurality of storage devices. The flexible multimode chip includes at least one serializer/deserializer core for proving an interface. A plurality of customizable gates is communicatively coupled to the at least one serializer/deserializer core. The plurality of customizable gates is configurable to define a communication protocol. A host interface module is included having a host interface processor for providing an interface with a host. A plurality of memory interface modules are also included for providing a memory interface to a plurality of storage devices, the memory interface modules communicatively coupled to the host interface module. A plurality of channel data control modules is communicatively coupled to the plurality of memory interface modules and the at least one serializer/deserializer core. The channel data control modules include a processor for managing context for the memory interface module.

In a further aspect of the present invention, a method for providing a flexible multimode chip includes designing an integrated circuit chip having a sufficient number of customizable gates to implement a communication protocol, the customizable gates implemented in a metal mask layer. The integrated circuit is configured for compliance with a specific protocol in final mask steps of the design of the integrated circuit by defining the specific protocol utilizing the customizable gates. The integrated circuit may also be configured for compliance with at least one specific feature set in final mask steps of the design of the integrated circuit by defining the specific feature set utilizing the customizable gates.

It is to be understood that both the forgoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is an illustration of an exemplary embodiment of the present invention in which a generic storage block architecture is depicted;

FIG. 2 is an illustration of an exemplary embodiment of the present invention wherein a multimode chip architecture is shown;

FIG. 3 is a block diagram depicting an exemplary embodiment of the present invention wherein a host interface module is shown;

FIG. 4 is a block diagram illustrating an exemplary embodiment of the present invention wherein a channel data control module is shown;

FIG. 5 is a block diagram of an exemplary embodiment of the present invention wherein a memory interface module is shown;

FIG. 6 is a block diagram of an exemplary embodiment of the present invention wherein a processor reference design is shown; and

FIG. 7 is a diagram illustrating an exemplary embodiment of the present invention wherein a multiprocessor reference design is shown.

### DETAILED DESCRIPTION OF THE INVENTION

Reference will now be made in detail to the presently preferred embodiments of the invention, examples of which are illustrated in the accompanying drawings.

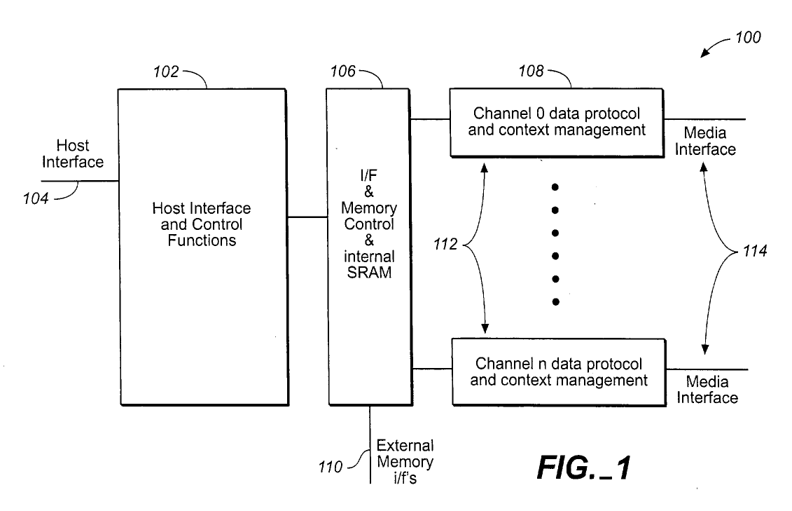

Referring generally now to FIGS. 1 through 7, exemplary embodiments of the present invention are shown. Manufacturers of integrated circuits are confronted with a variety of standards and protocols which exist for similar chip level products to develop for customers. Therefore, the cost of developing integrated circuits which utilize each of these highly complex designs continues to rise dramatically as the chip level geometries shrink, and the functional complexity of the chips rise. Existing solutions to these problems involve a full custom ASIC for each standard for inclusion by an integrated circuit, standard products for each standard to be serviced, and multi-chip solutions, such as through the use of a separate transceiver, processor, FPGA chips, and the like. However, when providing a full custom ASIC, optimal per unit cost with customer customization requires full engineering cost per chip as well as full ASIC design time. Additional engineering costs involving custom system level hardware and software may be incurred as well. Therefore, the provision of a custom solution for each customer may be expensive and difficult to recover.

Standard products do not allow customer differentiation, and therefore may not be optimal to the customer's needs. Although standard products may potentially spread the engineering costs across multiple customers, this may not be as cost efficient to the customer as a custom ASIC due to non-specific nature of the design. In other instances, system level hardware and software costs may be lower than with an ASIC depending on the needs of the customer.

Multi-chip solutions may be very costly, require a great deal of board space (and is therefore inefficient), power inefficient, and have lower data throughput. The present invention addresses these problems by providing reduced financial and engineering resource cost of development of a large class of related chip developments in order to enable a greater number of designs across a larger group of developers.

The present invention provides an architecture to address a class of storage designs enabling a standardized hardware and firm platform across multiple products. For example, the class of storage designs may include protocol, link, physical layer interface to communications media, and the like. Media may include a variety of interfaces, such as one to four Gigabit Ethernet interfaces, a single 10 Gigabit Ethernet XAUI interface, a single 10 Gigabit SPI-5 Narrow Mode interface, one to four SATA (Serial ATA) interfaces, one to four lanes of serial RapidIO(SRIO), one to four Fibre Channel (1-2-4 Gps) interfaces, iSCSI or FCIP interfaces layered on top of Ethernet interfaces, one to four SAS (Serial Attached SCSI) interfaces, and the like as contemplated by a person of ordinary skill in the art. Although specific interfaces and numbers are mentioned as examples, it should be apparent that a wide variety of interfaces, numbers, and the like are contemplated by the present invention as within the spirit and scope thereof.

Referring now to FIG. 1, an embodiment of the present invention is shown of a generic storage block architecture. The storage block architecture 100 includes a host interface and control functions 102 for the chip. The host interface 104 may be compatible with a wide range of protocols. For example, the “host” side of this design may support a standard PCI-X (such as PCI-X 1.0, PCI-X 2.0, PCI Express, and the like) interface that is compatible to either a server interface for host bus adapter (HBA) type designs, or to an internal bus for storage termination, bridging, or switching applications.

An interface, memory control and internal SRAM portion 106 of the architecture may be provided to link the data protocol and context management 108 to the host interface and control function 102, as well as to external memory interface(s) 110. A plurality of channel data control modules 112 are provided to communicatively couple to media interfaces 114, such as to a storage medium, and the like.

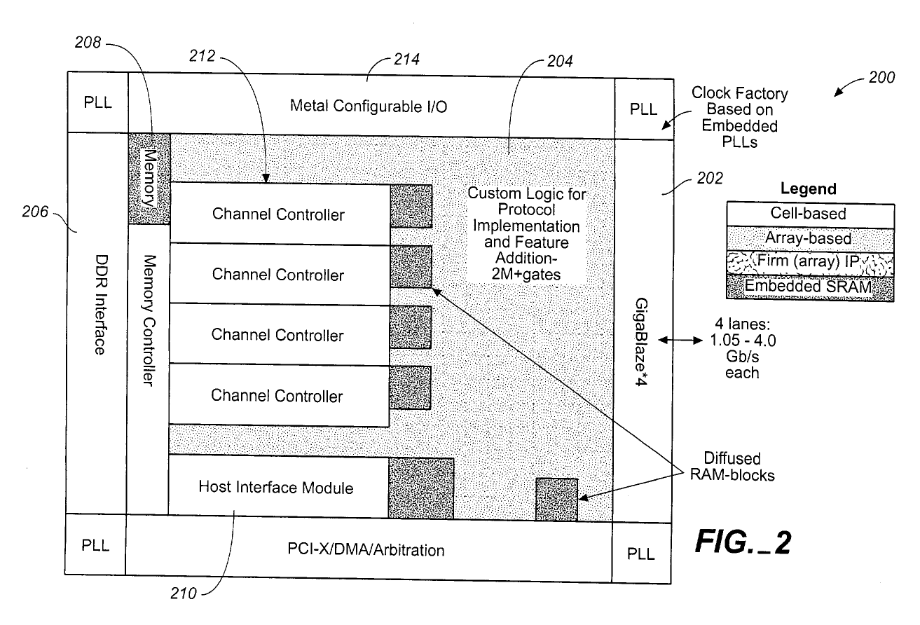

Referring now to FIG. 2, an embodiment of the present invention is shown wherein a multimode chip architecture 200 is described. Preferably, the architecture of the present invention utilizes interfaces implemented by instantiating serializer/deserializer (SerDes) cores on a multimode chip, such as GIGABLAZE cores (GigaBlaze is a trademark of LSI Logic Corporation). For instance, CMOS transceiver cores may be utilized which support multi-gigabit per second rates and provide full-duplex point-to-point communications channel for a gigabit speed serial interface. Preferably, the SerDes cores may be utilized as a physical layer for high-speed protocols, such as Fibre Channel, PCI Express, 10 Gigabit Ethernet, and the like. Multiple cores may be integrated into a single integrated circuit application, such as an ASIC, for applications such as storage subsystems, server platforms, network switches, routers, high-speed backplanes, and the like. For example, as shown in the example depicted in FIG. 2, four SerDes cores 202 are utilized in a preferred multimode chip architecture of the present invention.

A significant number of customizable gates 204, such as approximately two million gates in a preferred embodiment, are also included in the chip architecture. The gates may be utilized in a metal mask layer to define a protocol, such as Ethernet, FibreChannel, and the like, being carried over the external media as drive by the individual SerDes cores. In this way, at the final mask steps, the multimode chip may be configured for a specific application instantiation, with a significant portion of the common chip engineering work done in advance of the customization step.

Buffer memory access may be optionally included in the type designs. For example, one variation of the chip may incorporate a DDR memory controller interface 206 (FCRAM, SDRAM, DDR-2 variations and the like may also be utilized) for this purpose. Through use of the present invention, a multi-bus internal interface may be employed to make it easier to attach to the multiple data interface in the system, while maintaining high frequency timing closure, as well as supporting configurable priority access schemes, and built-in ECC support. Further, common access to on-chip memory with ECC support may also be included 208.

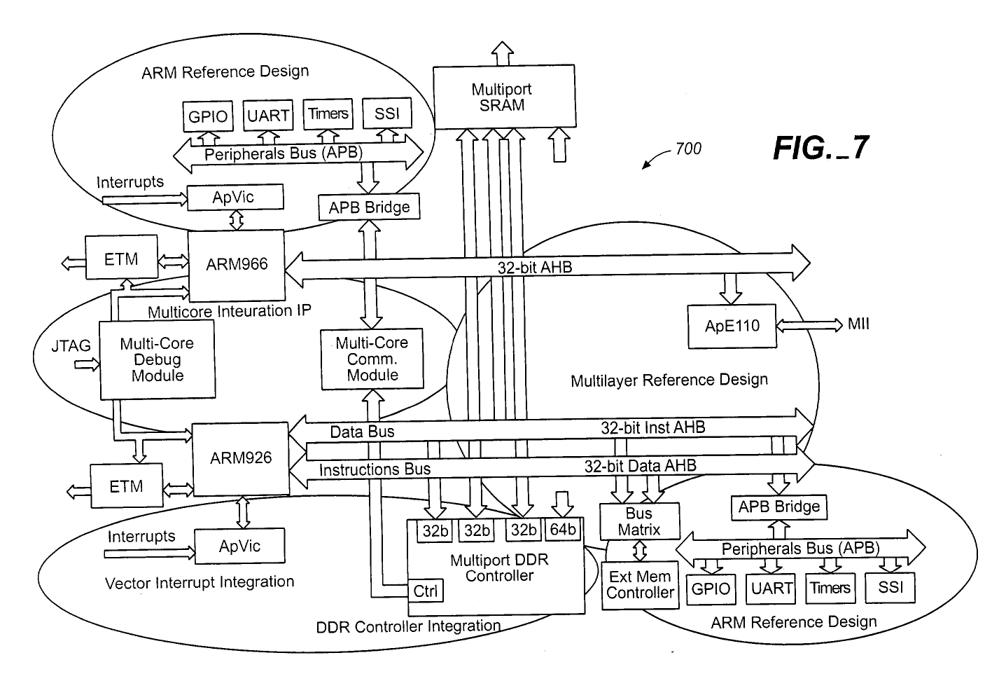

The systems cost aspect of the design of the present invention is a standardized multi-processor subsystem, such as the sub-system 700 shown in FIG. 7. As shown in FIG. 2, this subsystem includes a processor dedicated to host interface and system control in a host interface module 210, as well as processors to manage to context for each media interface included in channel data control modules 212. The host interface processor may be pre-diffused onto the architecture while the context processor would be ‘firm’ processor laid down as gates in order to support designs that utilize state machines rather than processors for the context management (SATA). Processors may include the processor 600 depicted in FIG. 6. The standardization of this multi-processor subsystem design will support code re-use, but also host software re-use at the driver and API level across multiple products. The design of the system is intended to support both manufacturer and customer proprietary systems.

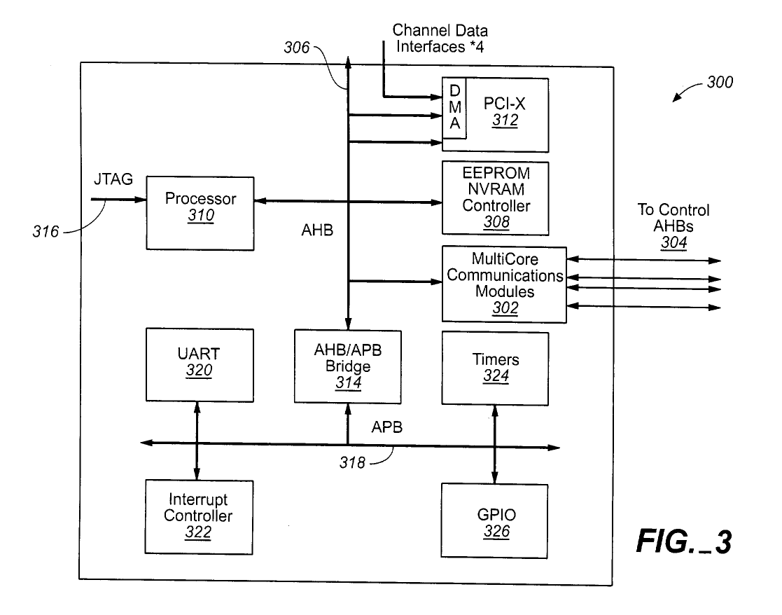

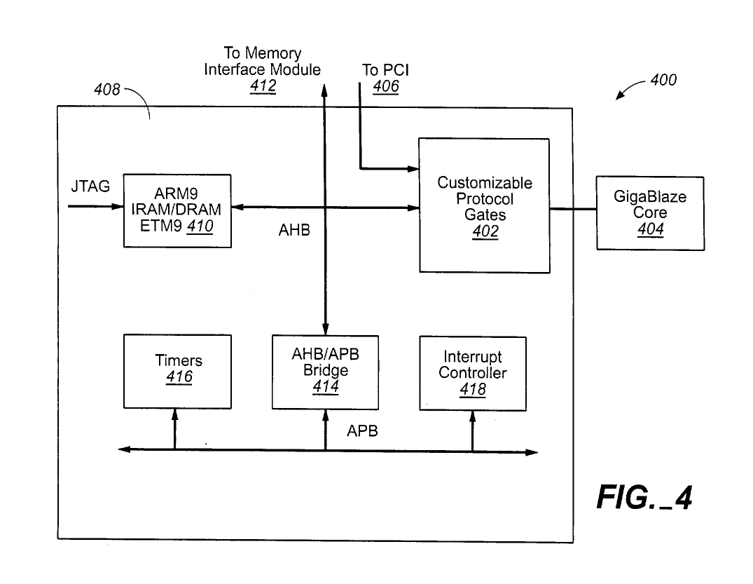

In FIG. 2, the host interface modules 210 and channel data control modules 212 are illustrated as being cell-based. However, in exemplary embodiments, as shown in FIG. 4, the channel data control modules 212 may contain customizable gates. Additionally, in other implementations one of more of the channel data control modules 212 may comprise customizable gates (for flexibility), which would in turn mean that the multicore communications module (MCM) 302, shown in FIG. 3, which is the host interface module, would also comprise customizable gates rather than being cell based.

Another systems cost saving aspect of this design is a firmware system that may be layered on top of this chip architecture. The firmware system may incorporate basic ideas and architecture (a firmware platform, API's, API interface definition, and the like), and also add software interfaces for customization, which may be restricted. Specifically, this firmware package may be made available in a binary executable or linkable form to run without change directly on this hardware platform, but also includes the ability to incorporate customer developed chip or application specific code in the form of libraries or routings that create or enable new feature for the specific instantiation of a chip based upon this multimode chip.

Referring again to FIG. 2, the additional hardware customization aspect of this design is a large number of customizable gates and blocks of memory 204 within the basic multimode chip to support customization of the instantiation of the chip to support a specific protocol, such as iSCSI over four Gigabit Ethernet interfaces 202, as well as customer specific features as needed, such as proprietary management pack handling, priority schemes, and custom packet grooming. Thus, the present invention provides a pre-defined and pre-designed high speed interfaces (SERDES ports) with metal configurable I/O's for flexibility 214.

Referring now to FIG. 3, an exemplary embodiment of the present invention is shown wherein a host interface module 300 is shown. The host interface module 300 includes multicore communications modules 302 to communicatively couple the host interface module 300 to control advanced host busses (AHBs) 304. An advanced host bus 306 is included within the module to communicatively couple an EEPROM NVRAM controller 308, processor 310, PCI-X module 312 and AHB/APB bridge 314. Preferably, the processor 310 includes a JTAG port 316. An advanced peripheral bus 318 is also included to communicatively couple a UART 320, interrupt controller 322, timers 324 and GPIO 326.

Referring now to FIG. 4, an exemplary embodiment of the present invention is shown wherein a channel data control module 400 is operable in the architecture depicted in FIG. 2. The channel data control module 400 may include customizable protocol gates 404 for linking to a SerDes core 404, such as a GigaBlaze core. The customizable protocol gates 404 may be communicatively coupled to PCI 406, as well as an AHB 408. The channel data control module 400 includes an advanced host bus 408 which communicativity couples a processor 410, memory interface module 412 and AHB/APB bridge 414. An APB communicatively couples timers 418 and an interrupt controller 418 with the AHB/APB bridge 414.

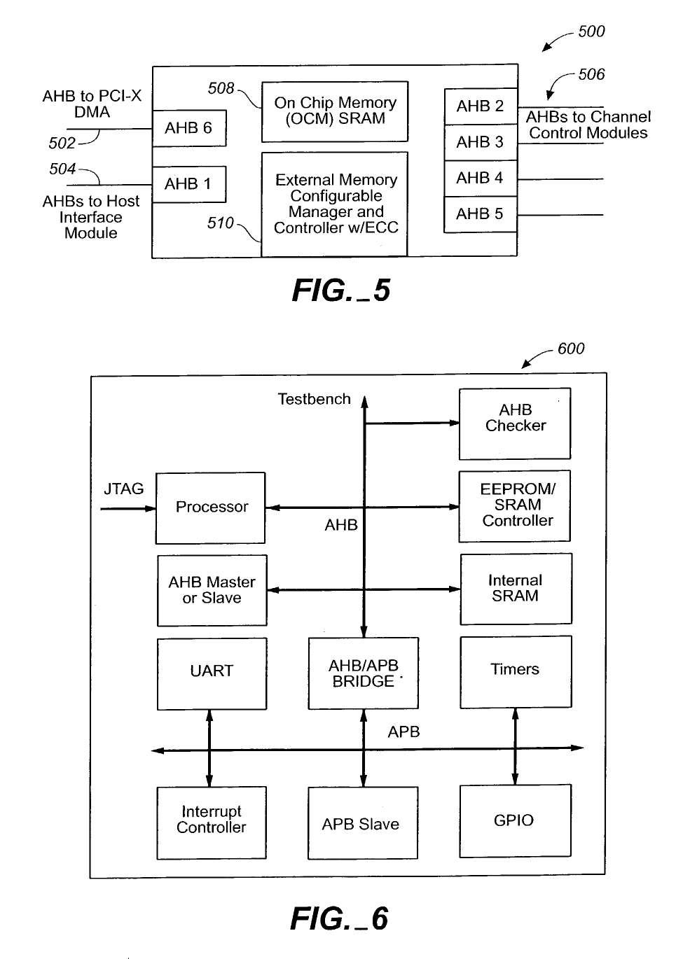

The channel data control module 400 may be communicatively coupled to a memory interface module 500, such as the module shown in the exemplary embodiment of the present invention depicted in FIG. 5. The memory interface module 500 interfaces AHB to PCI-X DMA 502 and AHBs to Host Interface Module 504 as shown in FIG. 3. The memory interface module 500 also interfaces via AHBs to channel control modules 506. Preferably, the memory interface module 500 includes on chip memory SRAM 508 and an external memory configurable manager and controller with ECC 510.

Therefore, the present invention may provide a pre-defined/designed high speed interfaces (SerDes ports) with metal configurable I/Os for flexibility. A large customizable gate area is included to implement link protocol specifics as well as customer/chip specific feature sets. Pre-defined/designed memory blocks may be employed for buffers, context processor memory and FIFO's common to chip design. An external and internal memory controller with ECC and shared configurable multiport access may also be included. Multiple processor systems may be pre-defined and designed, utilizing both diffused and optional firm processors as described previously in gates and reference instantiated. Inter-processor communication and control architecture may be defined and reference instantiated. Reference designs, as well as reference test benches to support multimode base chip, which may include Ethernet MAC, Ethernet PHY layer, Fibre Channel controllers, and the like. Further, the present invention provides the ability to instantiate additional processors/IP in customizable gates.

Although specific embodiments of the present invention have been described previously, it should be apparent that a wide range of modifications to the present invention may be made without departing from the spirit and scope of the present invention. For example, a variety number of SerDes interfaces may be employed, such as eight, six, four, two, one and the like. A variety of processor configurations may be employed, and may be chosen from a wide variety of processor types. Processors may be shared between ports for context management. The number of configurable gates may be chosen by the desired amount of flexibility as well as functionality desired. Varying fixed memory allocations may be made, and blocks of definable use memories may be instantiated of different size/placement from those specified in the previous discussion. Although a host interface employing PCI-X 1.0 has been described, PCI, PCI-X 2.0, PCI Express, and the like may also be useful. Buffer memory interface is optional. For instance some storage application may utilize a cut-through model, while Ethernet applications tend to employ a “store and forward” technique. Thus, the external memory interface may or may not be needed, depending on the application. This may be accomplished with different bond-outs to exclude the memory interface pin out, with a different variation on the multimode chip, and the like. Flash and/or EEPROM support may be provided as an option, as well as varying numbers of GPIO and serial port-control/debug interfaces are possible.

In exemplary embodiments, the methods disclosed may be implemented as sets of instructions or software readable by a device. Further, it is understood that the specific order or hierarchy of steps in the methods disclosed are examples of exemplary approaches. Based upon design preferences, it is understood that the specific order or hierarchy of steps in the method can be rearranged while remaining within the scope of the present invention. The accompanying method claims present elements of the various steps in a sample order, and are not meant to be limited to the specific order or hierarchy presented.

It is believed that the system and method of the present invention and many of its attendant advantages will be understood by the forgoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof. It is the intention of the following claims to encompass and include such changes.

What is claimed is:

1. A flexible multimode chip, comprising:
at least one serializer/deserializer core for proving an interface;
a plurality of customizable gates communicatively coupled to the at least one serializer/deserializer core, the plurality of customizable gates configurable to define a communication protocol and at least one specific feature set;
a host interface module including a host interface processor for providing an interface with a host;
a memory interface module for providing a memory interface to a storage device, the memory interface module communicatively coupled to the host interface module; and
a channel data control module communicatively coupled to the memory interface module and the at least one serializer/deserializer core, the channel data control module including a processor for managing context for the memory interface module.

2. The flexible multimode chip as described in claim 1, wherein multiple serializer/deserializer cores are utilized to provide the interface.

3. The flexible multimode chip as described in claim 1, wherein the plurality of customizable gates are implemented in a metal mask layer to define the protocol.

4. The flexible multimode chip as described in claim 1, wherein the protocol includes at least one of Ethernet and FibreChannel.

5. The flexible multimode chip as described in claim 1, further comprising buffer memory access.

6. The flexible multimode chip as described in claim 5, wherein the buffer memory access is provided through use of at least one of a DDR memory controller, FCRAM memory controller, SDRAM memory controller and DDR-2 memory controller.

7. The flexible multimode chip as described in claim 1, further comprising a multi-bus internal interface for communicatively coupling components of the flexible multimode chip.

8. The flexible multimode chip as described in claim 1, further comprising common memory accessible by components of the flexible multimode chip.

9. The flexible multimode chip as described in claim 1, wherein the host interface module includes a multicore communications module to communicatively couple the host interface module to control busses.

10. The flexible multimode chip as described in claim 1, wherein the memory interface module includes an external memory configurable manager and controller.

11. A data storage system, comprising:
a host system;
a plurality of storage devices, the plurality of data storage devices suitable for the storage of electronic data; and
a flexible multimode chip communicatively coupling the host system with the plurality of storage devices, the flexible multimode chip including
at least one serializer/deserializer core for proving an interface;
a plurality of customizable gates communicatively coupled to the at least one serializer/deserializer core, the plurality of customizable gates configurable to define a communication protocol;
a host interface module including a host interface processor for providing an interface with the host;
a plurality of memory interface modules for providing memory interfaces to the plurality of storage devices, the memory interface module communicatively coupled to the host interface module; and
a plurality of channel data control modules communicatively coupled to the plurality of memory interface modules and the at least one serializer/deserializer core, the channel data control modules including a processor for managing context for the memory interface module.

12. The data storage system as described in claim 11, wherein multiple serializer/deserializer cores are utilized to provide the interface.

13. The data storage system as described in claim 11, wherein the plurality of customizable gates are implemented in a metal mask layer to define the protocol.

14. The data storage system as described in claim 11, wherein the protocol includes at least one of Ethernet and FibreChannel.

15. The data storage system as described in claim 11, further comprising buffer memory access.

16. The data storage system as described in claim 15, wherein the buffer memory access is provided through use of at least one of a DDR memory controller, FCRAM memory controller, SDRAM memory controller and DDR-2 memory controller.

17. The data storage system as described in claim 11, further comprising a multi-bus internal interface for communicatively coupling components of the flexible multimode chip.

18. The data storage system as described in claim 11, further comprising common memory accessible by components of the flexible multimode chip.

19. The data storage system as described in claim 11, wherein the host interface module includes a multicore communications module to communicatively couple the host interface module to control busses.

20. The data storage system as described in claim 11, wherein the memory interface module includes an external memory configurable manager and controller.

21. A method for providing a flexible multimode integrated circuit chip, comprising:
designing an integrated circuit chip having a sufficient number of customizable gates to implement a communication protocol, the customizable gates implemented in a metal mask layer; and
configuring the integrated circuit for compliance with a specific protocol in final mask steps of the design of the integrated circuit by defining the specific protocol utilizing the customizable gates.

22. The method as described in claim 21, further comprising configuring the integrated circuit for compliance with at least one specific feature set in final mask steps of the design of the integrated circuit by defining the specific feature set utilizing the customizable gates.

23. The method as described in claim 22, wherein the specific feature set is specified by a customer.

24. A firmware system, comprising:
a firmware platform;
a flexible multimode chip supporting the firmware platform, including:
at least one serializer/deserializer core for proving an interface;
a plurality of customizable gates communicatively coupled to the at least one serializer/deserializer core, the plurality of customizable gates configurable to define a communication protocol and at least one specific feature set;
a host interface module including a host interface processor for providing an interface with a host;
a memory interface module for providing a memory interface to a storage device, the memory interface module communicatively coupled to the host interface module; and
a channel data control module communicatively coupled to the memory interface module and the at least one serializer/deserializer core, the channel data control module including a processor for managing context for the memory interface module.

25. The firmware system as described in claim 24, wherein multiple serializer/deserializer cores are utilized to provide the interface.

26. The firmware system as described in claim 24, wherein the plurality of customizable gates are implemented in a metal mask layer to define the protocol.

27. The firmware system as described in claim 24, wherein the protocol includes at least one of Ethernet and FibreChannel.

28. The firmware system as described in claim 24, wherein the flexible multimode chip further comprises buffer memory access.

29. The firmware system as described in claim 28, wherein the buffer memory access is provided through use of at least one of a DDR memory controller, FCRAM memory controller, SDRAM memory controller and DDR-2 memory controller.

30. The firmware system as described in claim 24, wherein the flexible multimode chip further comprises a multi-bus internal interface for communicatively coupling components of the flexible multimode chip.

31. The firmware system as described in claim 24, wherein the flexible multimode chip further comprises common memory accessible by components of the flexible multimode chip.

32. The firmware system as described in claim 24, wherein the host interface module includes a multicore communications module to communicatively couple the host interface module to control busses.

33. The firmware system as described in claim 24, wherein the memory interface module includes an external memory configurable manager and controller.
